(19) United States
(12) Patent Application Publication
(10) Pub. No.: US 2008/0049872 A1
(43) Pub. Date: Feb. 28, 2008

(54) METHOD AND DEVICE FOR MATCHING OUTPUT IMPEDANCE OF A TRANSMITTER

(75) Inventors: Christophe Fourtou, Saint-Cyr-Sur-Mer (FR); Frederic Hasbani, Hurtieres (FR)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: STMicroelectronics S.A., Montrouge (FR)

(21) Appl. No.: 11/840,401

(22) Filed: Aug. 17, 2007

(30) Foreign Application Priority Data
Aug. 22, 2006 (FR) 06/ 07451

(51) Int. Cl. H04L 25/10

(52) U.S. Cl. 375/317

(57) ABSTRACT

A device for matching an output impedance of a transmitter includes at least a first output terminal connected to a first static impedance external to said transmitter and forming a component of an equivalent static load, and a first programmable resistive component in series with the first impedance. The device further includes a reference voltage generator internal to said transmitter, a comparator receiving the reference voltage and a measurement voltage representative of the voltage on the terminals of the load as seen by the transmitter and generating a comparison signal representative of the comparison result, and a control unit generating a control signal depending on the comparison signal, in order to control at least the programmable resistive component.

### PRIORITY CLAIM

This application is a translation of and claims priority from French Application for Patent No. 06 07451 of the same title filed Aug. 22, 2006, the disclosure of which is hereby incorporated by reference.

### BACKGROUND OF THE INVENTION

1. Technical Field of the Invention

The present invention relates to a method and device for matching output impedance of a transmitter. More specifically, a method and device for matching an output impedance of a transmitter comprising at least a first output terminal connected to a first impedance external to said transmitter, and at least a first programmable resistive component in series with the first impedance, said first impedance forming a component of an equivalent load.

This technology is notably, but not exclusively, applied to unidirectional differential transmission of the High Speed Serial Link type, also denoted as HSL, from a processor to a display device, or from a camera to a processor. This technology is also applied in the case of non-differential transmission, a so-called simple link, in which the signal is transmitted on a single transmission wire.

2. Description of Related Art

In a communication between a transmitter and a receiver through a high frequency transmission line, supporting data exchanges at several gigabits per second (Gb/s), it is generally necessary to provide impedance matching between the transmitter and the receiver. With impedance matching, consisting of adjusting the output impedance of the transmitter to the end-of-line impedance as seen by the transmitter, i.e., the input impedance of the receiver, it is possible to reduce transmission interferences and limit the losses over the transmission line, thereby guaranteeing a maximum transfer of energy, and therefore an optimum bandwidth over the transmission line. Indeed, the closer the value of the output impedance of the transceiver to the value of the input impedance of the receiver, less there will be reflection on the transmission line, which has the consequence of providing a better signal-to-noise ratio and therefore better performance.

Poor impedance matching deteriorates the performances of the transmitter which cannot output all its power into the load, and the integrity of the aspect of the signal transmitted over the line therefore becomes critical.

Generally, the transmission line is connected, at each of its ends, to a matching impedance circuit, also called “buffer” by one skilled in the art. Now, in realizations up to the present time, the output impedance of the transmitter is adjusted, during a calibration step, to the impedance of a reference component, generally a reference resistor, external to the integrated circuit of the transmitter, without taking into account the input impedance of the receiver. Also, the input impedance of the receiver is adjusted to the impedance of another reference component, generally another reference resistor, external to the integrated circuit of the receiver.

However, although the use of a reference component external to the integrated circuit has the advantage of allowing the value of its impedance to be adjusted accurately, it has the drawback of using an additional terminal of the integrated circuit, and leads to a significant cost. In addition, as the receiver and the transmitter each have their own reference resistor, matching the impedances is not optimized in terms of the number of external components. Consequently, it is desirable to be able to achieve impedance matching which does not require the use of a reference resistor external to the integrated circuit of the transmitter.

In this context, there is a need for a device and a method for matching impedance, without at least any of the limitations mentioned earlier.

### SUMMARY OF THE INVENTION

In accordance with an embodiment, a method for matching an impedance comprises: establishing a reference voltage internal to said transmitter; comparing the reference voltage to a measurement voltage representative of the voltage on the terminals of the load as seen by the transmitter; generating a comparison signal representative of the comparison result; and sending a control signal depending on the comparison signal to the programmable resistive component in order to reduce the difference between the reference voltage and the measured voltage.

Thus, the difference between the value of the programmable resistive component and that of the first impedance is also reduced.

Preferably, the first impedance is a static impedance.

Preferably, the reference voltage and the measurement voltage are static voltages.

Advantageously, the reference voltage is established with the assumption that the value of the programmable resistive component is equal to that of the first impedance.

Preferably, the measurement voltage is representative of the voltage on the terminals of the first impedance.

Preferably, the measurement voltage is representative of the voltage on the terminals of the programmable resistive component.

For example, it is possible to apply a same offset voltage to the reference voltage and to the measurement voltage, without degrading the comparison signal.

The measurement voltage and the reference voltage may have a common potential, said common potential being constant relatively to a first or to a second potential.

Preferably, the common potential is a constant static potential relatively to the second potential.

Advantageously, the method also comprises a decision stem, applied if, for several successive comparisons, the control signal oscillates between two values, and consisting of giving to the control signal one of these two values.

The programmable resistive component is, for example, placed between said first output terminal and at least a first or a second potential.

The first impedance is for example placed between the first output terminal and the first or the second potential.

According to a particular embodiment, the transmitter further comprises a second output terminal connected to a second impedance identical with said first impedance, said load comprising at least said first and second impedances, the second impedance being placed between the second output terminal and the first or the second potential, the measurement voltage being representative of the voltage on the terminals of the first or the second impedance as seen by the transmitter between its first or its second output terminal and the first or the second potential.

According to another particular embodiment, the transmitter further comprises a second output terminal connected to a second impedance identical with said first impedance, said load comprising at least said first and second impedances mounted in series between the first and second output terminals, the measurement voltage being representative of the voltage on the terminals of the load as seen from the transmitter between its first and second output terminals.

According to another particular embodiment, the transmitter further comprises a second output terminal connected to a second impedance identical with said first impedance, said load comprising at least said first and second impedances mounted in series between the first and second output terminals, and wherein the measurement voltage is representative of the voltage between the first and the second output terminal and the first or the second potential.

In accordance with an embodiment, a device for matching an output impedance of a transmitter comprises: a first output terminal connected to a first impedance external to said transmitter and forming a component of an equivalent load; and a first programmable resistive component in series with the first impedance. The device further comprises: a reference voltage generator internal to said transmitter; a comparator receiving the reference voltage and a measurement voltage representative of the voltage on the terminals of the load as seen from the transmitter, and generating a comparison signal representative of the comparison result; and a control unit generating a control signal depending on the comparison signal, in order to control at least the programmable resistive component.

The reference voltage is for example generated by a resistive bridge formed with several resistors mounted in series between the first and second potentials.

Preferably, the reference voltage is established with the assumption that the value of the programmable resistive component is equal to that of the first impedance.

Preferably, the measurement voltage is representative of the voltage on the terminals of the programmable resistive component.

Preferably, the measurement voltage and the reference voltage have a common potential, said common potential being constant relatively to the first or to the second potential.

The programmable resistive component is for example placed between said first output terminal and at least the first or second potential.

Advantageously, the first impedance is placed between the first output terminal and the first or second potential.

The programmable resistive component may be formed with several elementary assemblies placed in parallel, each elementary assembly consisting of a resistor and of a switching transistor, and being selected by activation of the gate of said switching transistor.

The programmable resistive component may be formed with several transistors used as a resistor.

The programmable resistive component may be formed with at least one elementary assembly consisting of at least one resistor and one transistor used as a resistor.

According to a particular embodiment of the invention, the transmitter further comprises a second output terminal connected to a second impedance external to said transmitter and identical with said first impedance, said load comprising at least said first and second impedances, the second impedance being placed between the second output terminal and the first or second potential, the measurement voltage is representative of the voltage on the terminals of the first or second impedance as seen by the transmitter between its first and its second output terminal and the first or second potential.

According to another particular embodiment of the invention, the transmitter further comprises a second output terminal connected to a second impedance external to said transmitter and identical with said first impedance, said load comprising at least said first and second impedances mounted in series between the first and second output terminals, the measurement voltage being representative of the voltage on the terminals of the load as seen from the transmitter between its first and second output terminals.

According to another particular embodiment, the transmitter further comprises a second output terminal connected to a second impedance identical with said first impedance, said load comprising at least said first and second impedances mounted in series between the first and second output terminals, the measurement voltage being representative of the voltage between the first or second output terminal and the first or second potential.

Advantageously, the programmable resistive component is integrated into the structure of an integrated circuit of the current-switching logic type mounted between the first and second potentials, and comprising first and second outputs connected to the first and second output terminals respectively.

According to another particular embodiment of the invention, the equivalent load is the input impedance of a receiver connected to the transmitter via a transmission line.

In an embodiment, an impedance matching circuit for a transmitter connected to a load at a pair of differential output terminals comprises: a first programmable resistance connected between a first output terminal and a first reference voltage; a second programmable resistance connected between a second output terminal and a second reference voltage; a comparator circuit having a first input receiving a fixed reference voltage and a second input receiving a sensed voltage from at least one of the first and second output terminals; and a control circuit responsive to an output of the comparator circuit to adjust the first and second programmable resistances so as to reduce a difference between the fixed reference voltage and sensed voltage as measured by the comparator circuit.

In an embodiment, an impedance matching circuit for a transmitter connected to a load at an output terminal comprises: a programmable resistance connected between the output terminal and a reference voltage; a comparator circuit having a first input receiving a fixed reference voltage and a second input receiving a sensed voltage from the output terminal; and a control circuit responsive to an output of the comparator circuit to adjust the programmable resistance so as to reduce a difference between the fixed reference voltage and sensed voltage as measured by the comparator circuit.

### BRIEF DESCRIPTION OF THE DRAWINGS

Other characteristics and advantages will become more clear after reading the following description given as an illustrative and non-limitative example with reference to the appended figures, wherein:

FIG. 1 shows a block diagram of a communications device applying the invention;

FIG. 2 illustrates the implementation of the invention for matching impedance to a differential load according to the invention, in the case of transmission over a differential line;

FIGS. 3a and 3b illustrate the implementation of the invention for matching to a non differential load according to the invention in the case of transmission over a differential line;

FIG. 4 shows a first particular embodiment of the invention in the case of FIG. 2;

FIGS. 5a and 5b respectively show second and third particular embodiments of the invention in the respective cases of FIGS. 3a and 3b;

FIGS. 6a and 6b illustrate the implementation of the invention for matching to a non differential load according to the invention, in the case of non-differential transmission; and

FIGS. 7a, 7b and 7c show exemplary embodiments of the programmable resistive component.

### DETAILED DESCRIPTION OF THE DRAWINGS

Only the components required for understanding the invention are illustrated in the figures and described hereafter.

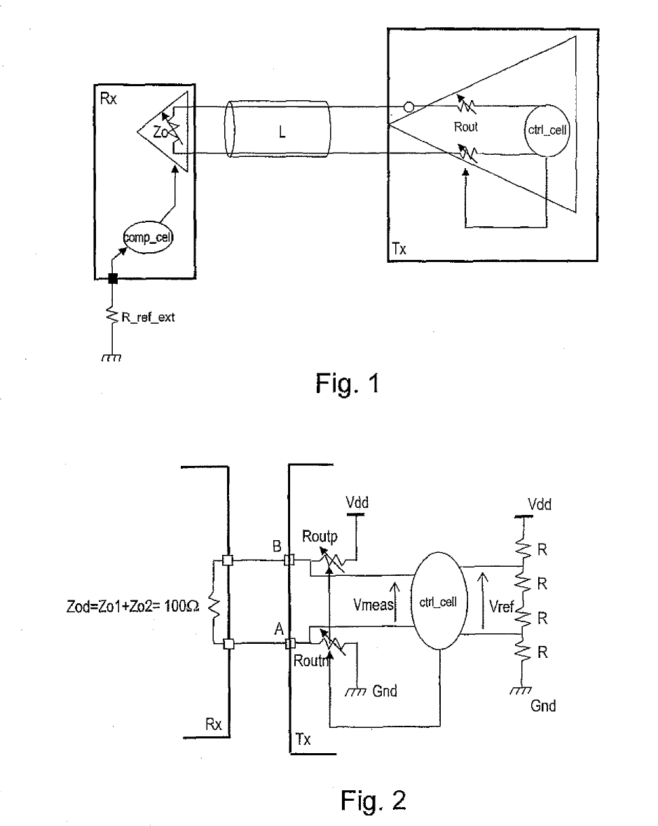

FIG. 1 shows the general diagram of a communications device implementing the invention applied to the particular case of differential transmission of data between a transmitter and a receiver. This communications device comprises a receiver Rx connected to a transmitter Tx via a differential transmission line L. Transmission of data through this transmission line L between the transmitter Tx and the receiver Rx is carried out after a step for calibrating the receiver Rx and the transmitter Tx, consisting of matching the input impedance of the receiver Rx and the output impedance of the transmitter Tx, respectively.

The receiver Rx comprises a circuit for matching its input impedance known from the prior art, comprising: an external reference resistor R_ref_ext placed outside the integrated circuit of the receiver Rx, and the value of which is set before any calibration step; a compensation cell comp_cell; and an adjustable input impedance. During the step for calibrating the receiver, the compensation cell comp_cell equalizes the value of the adjustable input impedance of the receiver Rx to that of the external reference resistor R_ref_ext. The input impedance of the receiver, which is therefore accurately controlled, may then be used as a reference impedance for the output impedance of the transmitter.

The transmitter Tx, in the case of differential transmission, for example comprises at least: a first output terminal A and a second output terminal B, each of which is respectively connected to a first and second impedances Zo1 and Zo2 forming an equivalent load, the equivalent load being in this case the input impedance of the receiver Rx, for example the first and second impedances each being equal to 50 ohms; and an output impedance matching device.

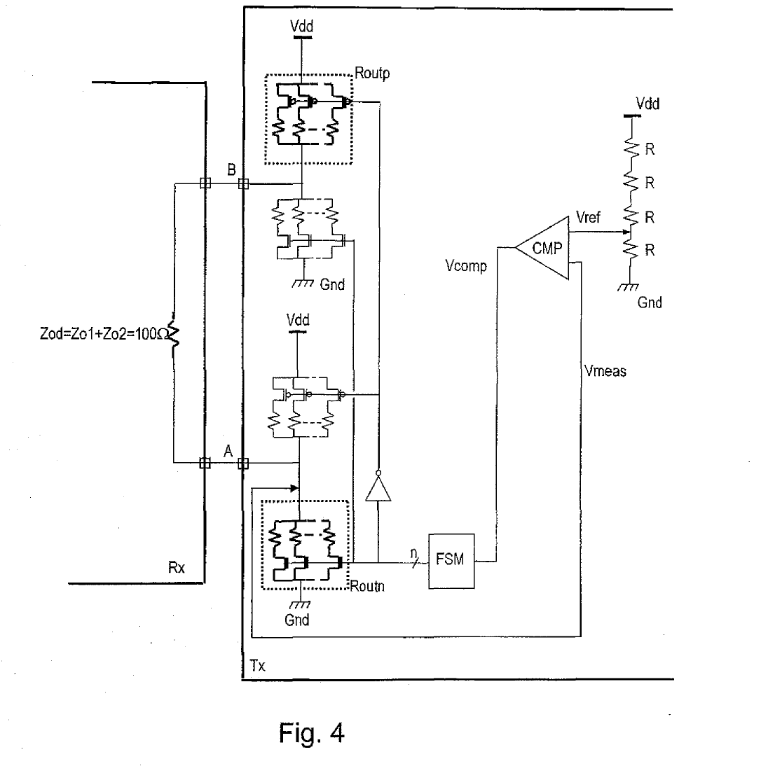

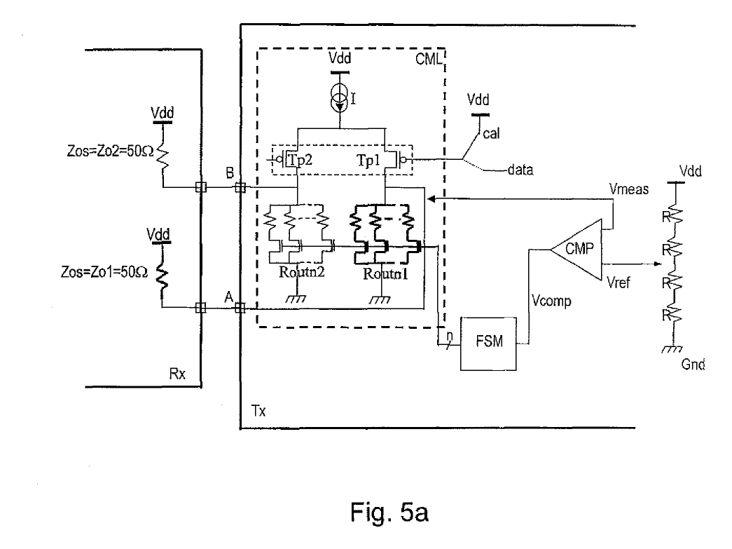

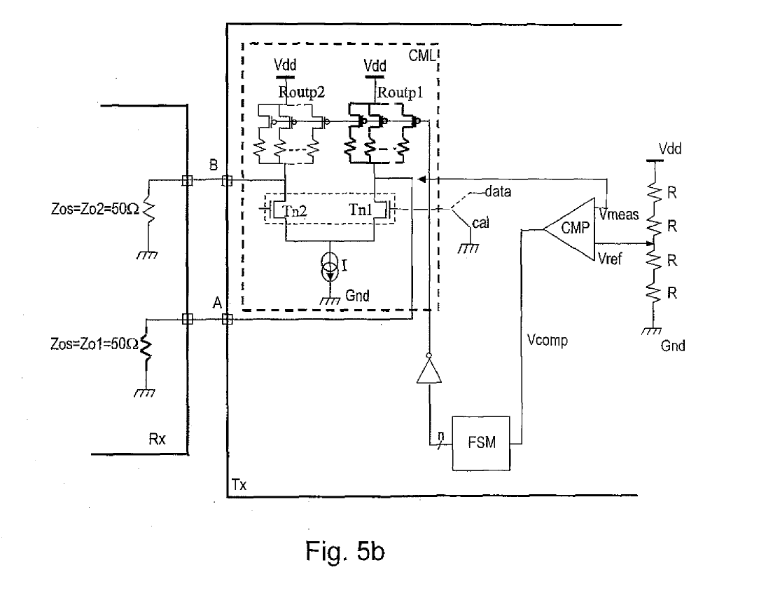

As illustrated in FIGS. 4, 5a and 5b, the impedance matching device for example comprises at least one programmable resistive component Rout in series with the load, a voltage reference Vref generator internal to the transmitter, and a control cell ctrl_cell. The control cell ctrl_cell for example comprises at least: a comparator CMP receiving the reference voltage Vref and a measurement voltage Vmeas representative of the voltage on the terminals of the load as seen by the transmitter Tx between its first and second output terminals A, B, and generating a comparison signal Vcomp; and a control unit FSM generating a control signal depending on the comparison signal Vcomp, in order to control at least the programmable resistive component. The voltage generator may be a resistive bridge formed with several resistors R mounted in series between a first potential Vdd, for example a power supply voltage, and a second potential Gnd, for example the ground.

In this configuration, the reference voltage outputted by the voltage generator depends only on the first potential and resistances, and is thus independent of the measurement voltage representative of the voltage on the terminals of the load as seen by the transmitter.

The programmable resistive component Rout may be formed with several elementary assemblies placed in parallel, each elementary assembly consisting of a resistor and of a transistor and being selected by activation of the gate of said transistor.

The control signal n may, in this case, be a digital signal, the value of which is representative of the number of transistors to be selected, thereby allowing an adjustment of the value of the programmable resistive component Rout.

The control unit FSM may then be a digital encoder of the finite state machine type, as known to one skilled in the art. Such a machine is a sequential logic circuit generating control signals, and the state of which represent all the values which the internal variables of the circuit may assume.

Generally, during the step for calibrating the transmitter Tx, the internal reference voltage Vref of the transmitter Tx is established, for example with the assumption that the value of the resistive component Rout is equal to that of the first impedance Zo1. Thus, formally and in the case of matching the output impedance of a non-differential transmitter, the measurement voltage Vmeas is given by equation (1a):

$$Vmeas = Vdd \cdot \frac{Zos}{Zos + Rout} , \qquad ( 1 a )$$

wherein Zos is the so-called real single-ended impedance loading the transmitter Tx, i.e., the end-of-line parallel matching resistance, integrated to the receiver Rx or placed on the board, and therefore the first impedance Zo1.

Also, formally and in the case of output impedance matching of a differential transmitter, the measurement voltage Vmeas is given by equation (1b):

$$Vmeas = Vdd \cdot \frac{Zod}{Zod + {Rout}_{n} + {Rout}_{n}} ≅ Vdd \cdot \frac{Zod}{Zod + 2 \cdot Rout} , \qquad ( 1 b )$$

wherein Zod is the real differential impedance loading the transmitter Tx. It is generally integrated to the receiver Rx. Zod is therefore equal to the sum of the value of the first and second impedances Zo1, Zo1. Zod may be broken down into two impedances Zos placed in series, in this case equation (1a) applies.

The reference voltage is given by equation (2):

$$Vcomp {⟶}^{Zas = Rout} 0 \qquad ( 4 )$$

This reference voltage Vref is then compared with the measurement voltage Vmeas, and a comparison signal Vcomp representative of the result of comparison is generated and sent to the control unit FSM.

The measurement voltage Vmeas is given by:
Vcomp=Vmeas−Vref, (3)

The control unit FSM, depending on the comparison signal Vcomp, sends to the programmable resistive component Rout a control signal n in order to reduce the difference between the reference voltage Vref and the measured voltage Vmeas:

$$Vref = Vdd \cdot \frac{1}{2} \qquad ( 2 )$$

For example, the control unit FSM contains an initial value. On the first comparison, if the reference voltage Vref is larger than the measurement voltage Vmeas, meaning that the value of the programmable resistive component Rout is too small, then the control unit FSM sends a first digital signal, the value of which is less than this initial value, and keeps the value of this first digital signal in memory. On the second comparison, if the reference voltage Vref is still larger than the measurement voltage Vmeas, the control unit FSM then sends a second digital signal, the value of which is less than the first digital value, and keeps the value of this second digital signal in memory.

Thus, the control unit n, depending on the comparison signal Vcomp, sends a control signal n, the value of which is larger or less than the value of the control signal sent as a result of a prior comparison, in order to select or unselect for example an elementary assembly, so as to reduce the difference between the measurement voltage Vmeas and the reference voltage Vref.

Additionally, if the control signal n for example oscillates between two values for several successive comparisons, the control unit FSM takes the decision of setting the control signal to one of these two values.

Moreover, it is preferable but not mandatory that the measurement voltage Vmeas and the reference voltage Vref have a common potential, i.e., a same referential. This common potential for example is the second potential Gnd. The application is thereby easier, and matching accuracy is improved.

These preferences will be selected for the different particular embodiments of the invention presented hereafter.

FIGS. 2 and 4 show a first embodiment, in the case of matching impedance to a load of the differential type Zod, for example equal to 100 ohms, and in the case of transmission over a differential line. The differential load in this particular case consists of the first impedance Zo1 and of the second impedance Zo2 mounted in series between the first and second output terminals A, B, each of the impedances Zo1, Zo2 having the value of 50 ohms.

In this first embodiment, the impedance matching device comprises: the reference voltage generator Vref internal to the transmitter; the control cell ctrl_cell; a programmable resistive component Rout of type P, denoted as Routp, mounted between the first potential Vdd and the second output terminal B, and in which the transistors are PMOS (p channel metal oxide semiconductor) type transistors for example; and a second programmable resistive component of type N, denoted as Routn, mounted between the second potential Gnd and the first output terminal A, and in which the transistors are NMOS (n channel metal oxide semiconductor) type transistors for example.

The programmable resistive components of type P Routp and of type N Routn have the same number of elementary assemblies. The programmable resistive component of type N, Routn, is directly controlled by the control signal n, and the programmable resistive component of type P, Routp, is controlled by a signal inverse to the control signal n.

In this configuration, it is then sufficient to take the voltage on the terminals of the N type programmable resistive component Routn as the measurement voltage Vmeas on the one hand, and to adjust the reference voltage Vref on the other hand with the assumption that the values of the programmable resistive components of type P, Routp, and of type N, Routn, are equal to half the input impedance of the receiver, i.e. 50 ohms. In this case, the reference voltage Vref is set to the quarter of the value of the first potential Vdd.

Thus, as the programmable resistive components of type P, Routp, and of type N, Routn, have the same number of elementary assemblies, when the difference between the reference voltage Vref and the measurement voltage Vmeas is reduced, the difference between the input impedance of the receiver and the sum of the values of the programmable resistive component of type N and of type P is also reduced.

The transmitter also comprises: another programmable resistive component of type N used for differential transmission of data, identical with the programmable resistive component of type N, Routn, used for impedance matching, and mounted between the second potential Gnd and the second output terminal B; and another programmable resistive component of type P also used for differential transmission of data, identical with the programmable resistive component of type P, Routp, used for impedance matching, and mounted between the first potential Vdd and the first output terminal A.

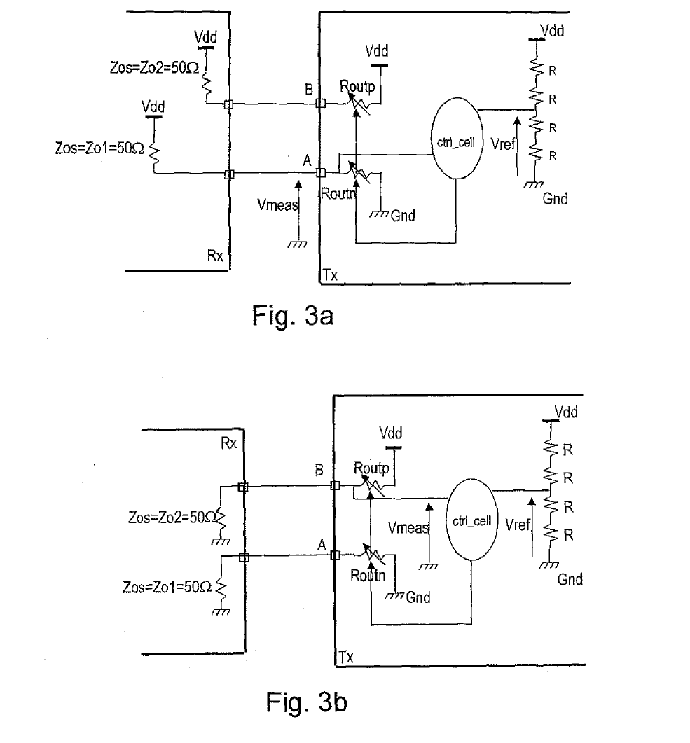

FIGS. 3a and 5a show a second embodiment in the case of matching impedance to a load of the non-differential type, and in the case of transmission over a differential line. Each output terminal A, B is connected to a first and second impedance Zo1 and Zo2 (Zos=Zo1−Zo2), for example each of 50 ohms, forming the equivalent load, respectively. Each of these impedances Zo1, Zo2 is connected to the first potential Vdd on the end which is not connected to an output terminal.

In this second embodiment, the transmitter Tx comprises the Vref reference voltage generator internal to the transmitter Tx, the control cell ctrl_cell, and the programmable resistive component Rout integrated into the structure of an integrated circuit of the current-switching logic type known to one skilled in the art and denoted as CML. The CML logic circuit is mounted between the first and second potentials Vdd, Gnd, and comprises first and second outputs, connected to the first and second output terminals A, B, respectively.

More specifically, the CML logic circuit comprises a differential pair consisting of first and second paired transistors Tp1, Tp2, and polarized by a current source I. The first and second transistors Tp1, Tp2 are respectively connected to first and second programmable resistive components of type N, Routn1, Routn2, controlled by the control signal n. During the calibration, the gates of both transistors Tp1, Tp2 are connected to the first potential Vdd. The reference voltage Vref is equal to half the first potential Vdd and the measurement voltage Vmeas is taken on the terminals of the first programmable resistive component of type N, Routn1. During differential transmission of data, the gates of the first and second transistors, Tr1p, Tr2p, are connected to a data transmission potential.

FIGS. 3b and 5b show the invention in a third embodiment in the case of matching impedance to a load of the non-differential type and in the case of transmission over a differential line. Each output terminal A, B is connected to first and second impedances Zo1, Zo2 (Zos=Zo1=Zo2), respectively, for example each of 50 ohms, forming the equivalent load. Each of these impedances Zi1, Zo2 is connected to the second potential Vdd on the end which is not connected to an output terminal.

In this third embodiment, the transmitter Tx comprises the Vref reference voltage generator internal to the transmitter, the control cell Ctrl_cell, and the programmable resistive component Rout integrated into the CML logic circuit. The CML logic circuit is mounted between the first and second potentials Vdd, Gnd, and comprises first and second outputs connected to the first and second output terminals A, B, respectively. More specifically, the CML logic circuit, in this case, comprises a differential pair consisting of third and fourth paired transistors Tn1, Tn2 and polarized by a current source I. The third and fourth transistors Tn1, Tn2, are respectively connected to first and second programmable resistive components of type P, Routp1, Routp2.

During the calibration, the gates of both transistors Tn1, Tn2, are connected to the second potential Gnd. The reference voltage Vref is equal to half the first potential Vdd and the measurement voltage Vmeas is taken on the terminals of the first programmable resistive component of type P, Routp1. During differential transmission of data, the gates of both transistors T1n, Tn2 are connected to a data transmission potential.

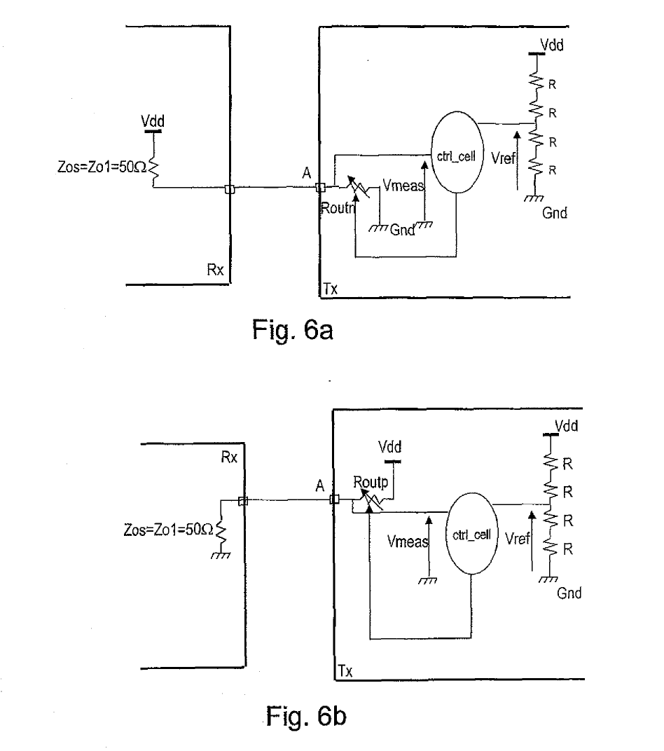

FIG. 6a shows a fourth embodiment in the case of matching impedance to a load of the non-differential type, for example equal to 50 ohms, and in the case of non-differential transmission, i.e., using a single wire. In this fourth embodiment, the impedance matching device comprises the Vref reference voltage generator internal to the transmitter, the control cell ctrl_cell, the programmable resistive component of type N, Routn, mounted between the second potential Gnd and the first output terminal A. In this configuration, the measurement voltage Vmeas is taken on the terminals of the programmable resistive component of type N, Routn. The programmable resistive component of type N, Rout, is controlled by the control signal n.

FIG. 6b shows a fifth embodiment in the case of matching impedance to a load of the non-differential type, for example equal to 50 ohms, and in the case of non-differential transmission, i.e., using a single wire. In this fifth embodiment, the impedance matching device comprises the Vref reference voltage generator internal to the transmitter, the control cell ctrl_cell, the programmable resistive component of type P, Routp, mounted between the first potential Vdd and the first output terminal A. In this configuration, the measurement voltage Vmeas is taken between the first output terminal A and the second potential Vdd. The programmable resistive component of type N, Routn, is controlled by the control signal n.

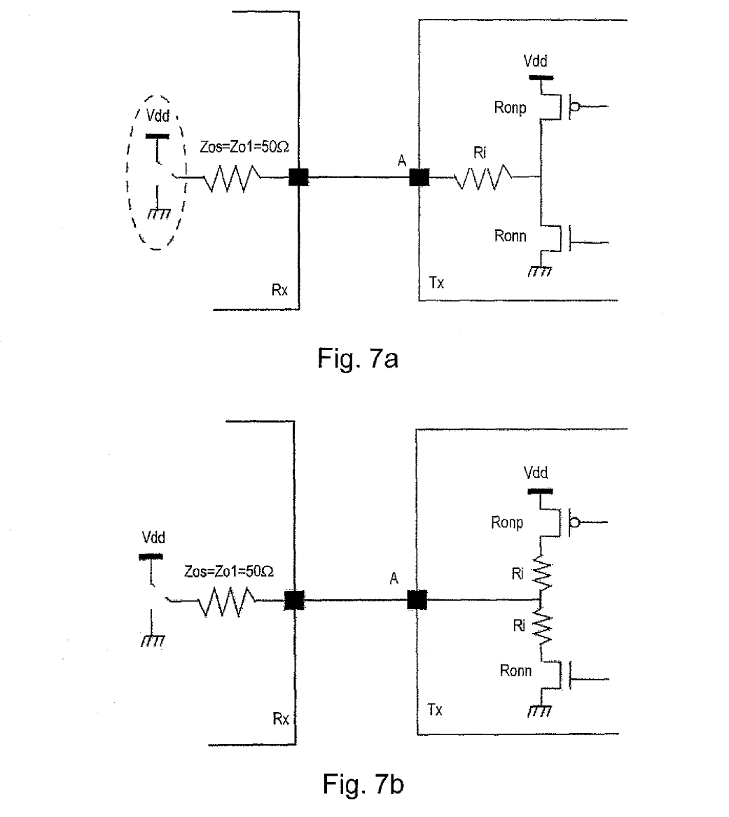

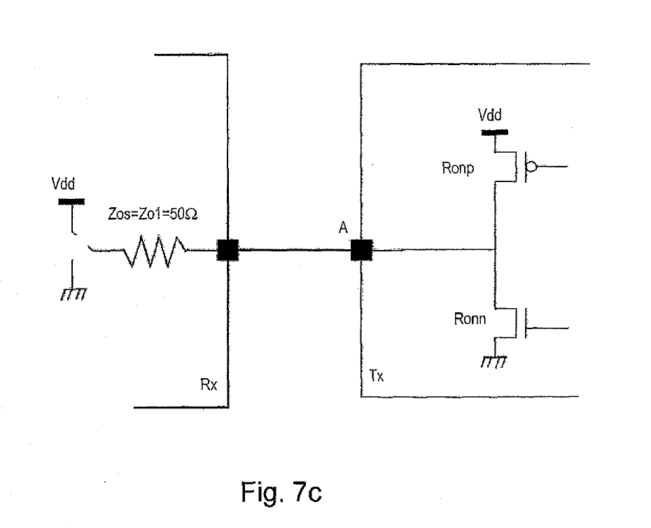

FIGS. 7a, 7b and 7c show exemplary embodiments of the programmable resistive component Rout, with which the transmitter may be adapted to either of the configurations shown in FIGS. 6a and 6b.

For example in FIG. 7a, the programmable resistive component Rout consists of a p type transistor Ronp and of an n type transistor Ronn mounted in series between the first and second potentials Vdd, Gnd, and of an integrated resistor Ri mounted between the first output terminal A and the intersection point of the p type and n type transistors. Thus, the equivalent resistance of the output buffer has the value: Ronp+Ri=Ronn+Ri, with Ri being the integrated resistance, and Ronn=Ronp the equivalent resistance of the transistors.

FIG. 7b shows another alternative of the programmable resistive component Rout shown in FIG. 7a. In this embodiment, the programmable resistive component comprises an n type transistor and a p type transistor, as well as two integrated resistors Ri, the whole of these components being mounted in series between the first and second potentials Vdd, Gnd. The equivalent resistance of the output buffer also has the value: Ronp+Ri=Ronn+Ri, with Ri the integrated resistance and Ronn=Ronp the equivalent resistance of the transistors.

FIG. 7c shows another alternative of the programmable resistive component. In this embodiment, the programmable resistive component consists of a p type transistor Ronp and of an n type transistor Ronn used as resistors and mounted in series between the first and second potentials Vdd, Gnd. In this case, the equivalent resistance of the output buffer has the value: Ronp=Ronn. The programmable resistive component may also consist of several p type transistors placed in parallel and several n type transistors placed in parallel.

The programmable resistive component made according to FIGS. 7a-7c may be controlled by the control unit FSM, and these different non-limiting embodiments of the programmable resistive component are of course applicable to the case of a differential transmission.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for matching an output impedance of a transmitter comprising at least a first output terminal connected to a first static terminating impedance, external to said transmitter, and at least a first programmable resistive component in series with the first impedance, said first impedance forming a component of an equivalent static load, comprising:
establishing a static reference voltage internal to said transmitter and independent of a static measurement voltage representative of the voltage on the terminals of the load as seen from the transmitter;
comparing the reference voltage to the static measurement voltage;
generating a comparison signal representative of the comparison result; and
sending a control signal depending on the comparison signal to the programmable resistive component in order to reduce the difference between the reference voltage and the measured voltage.

2. The method according to claim 1, wherein the reference voltage is established with the assumption that the value of the programmable resistive component is equal to that of the first impedance.

3. The method according to claim 1, wherein the measurement voltage is representative of the voltage on the terminals of the first impedance.

4. The method according to claim 1, wherein the measurement voltage is representative of the voltage on the terminals of the programmable resistive component.

5. The method according to claim 1, further comprising a decision step applied if, for several successive comparisons, the control signal oscillates between two values, and consisting of giving one of these two values to the control signal.

6. The method according to claim 1, wherein the transmitter further comprises a second output terminal connected to a second impedance identical with said first impedance, said load comprising at least first and second impedances, the second impedance being placed between the second output terminal and a first or second potential, and wherein the measurement voltage is representative of the voltage on the terminals of the first or second impedance (as seen by the transmitter between its first or second output terminal and the first or second potential.

7. The method according to claim 1, wherein the transmitter further comprises a second output terminal connected to a second impedance identical with said first impedance, said load comprising at least said first and second impedances mounted in series between the first and second output terminals, and wherein the measurement voltage is representative of the voltage on the terminals of the load as seen from the transmitter between its first and second output terminals.

8. The method according to claim 1, wherein the transmitter further comprises a second output terminal connected to a second impedance identical with said first impedance, said load comprising at least said first and second impedances mounted in series between the first and second output terminals, and wherein the measurement voltage is representative of the voltage between the first or second output terminal and the first or second potential.

9. The method according to claims 1, wherein the measurement voltage and the reference voltage have a common potential, said common potential being constant relatively to the second potential.

10. A device for matching an output impedance of a transmitter comprising:
a first output terminal connected to a first static terminating impedance external to said transmitter and forming a component of an equivalent static load;
a first programmable resistive component in series with the first impedance;
a static reference voltage generator internal to said transmitter, said static reference voltage being independent of a measurement voltage representative of the voltage on the terminals of the load as seen by the transmitter;
a comparator receiving the reference voltage and the measurement voltage representative of the voltage on the terminals of the load as seen by the transmitter, and generating a comparison signal representative of the comparison result; and
a control unit generating a control signal depending on the comparison signal, in order to control at least the programmable resistive component.

11. The device according to claim 10, wherein the measurement voltage is representative of the voltage on the terminals of the programmable resistive component.

12. The device according to claim 10, wherein the first impedance is placed between the first output terminal and a first or second potential.

13. The device according to claim 10, wherein the transmitter further comprises a second output terminal connected to a second impedance external to said transmitter and identical with said first impedance, said load comprising at least said first and second impedances, the second impedance being placed between the second output terminal and the first or second potential, and wherein the measurement voltage is representative of the voltage on the terminals of the first or second impedance as seen by the transmitter between its first or its second output terminal and the first or second potential.

14. The device according to claim 10, wherein the transmitter further comprises a second output terminal connected to a second impedance external to said transmitter and identical with said first impedance, said load comprising at least said first and second impedances mounted in series between the first and second output terminals, and wherein the measurement voltage is representative of the voltage on the terminals of the load as seen from the transmitter between its first and second output terminals.

15. The device according to claim 10, wherein the transmitter further comprises a second output terminal connected to a second impedance identical with said first impedance, said load comprising at least said first and second impedances mounted in series between the first and second output terminals, and wherein the measurement voltage is representative of the voltage between the first or second output terminals and the first or second potential.

16. The device according to claim 10, wherein the measurement voltage and the reference voltage have a common potential, said common potential being constant relatively to the second potential.

17. The device according to claim 10, wherein the programmable resistive component is integrated into the structure of an integrated circuit of the current-switching logic type mounted between the first and the second potentials, and comprising first and second outputs connected to the first and second output terminals, respectively.

18. The device according to claim 10, wherein the equivalent load is the static input impedance of a receiver connected to the transmitter via a transmission line.

19. The device according to claim 10, wherein the programmable component comprises:
one elementary assembly comprising a resistor and a transistor, the elementary assembly being selected by activating the gate of said transistor, and forming the output impedance of the transmitter; or
one transistor used as a resistor and forming the output impedance of the transmitter.

20. An impedance matching circuit for a transmitter connected to a load at a pair of differential output terminals, comprising:
a first programmable resistance connected between a first output terminal and a first reference voltage;
a second programmable resistance connected between a second output terminal and a second reference voltage;
a comparator circuit having a first input receiving a fixed reference voltage and a second input receiving a sensed voltage from at least one of the first and second output terminals; and
a control circuit responsive to an output of the comparator circuit to adjust the first and second programmable resistances so as to reduce a difference between the fixed reference voltage and sensed voltage as measured by the comparator circuit.

21. The circuit of claim 20 wherein the load is of the differential type.

22. The circuit of claim 20 wherein the load is of the non-differential type.

23. The circuit of claim 22 wherein the first and second reference voltages are a same reference voltage.

24. The circuit of claim 20 wherein each of the first and second programmable resistance comprises:
first and second transistors source/drain connected in series at a common node, the gates of the first and second transistors being coupled to receive signals output from the control circuit; and
a resistor connected between the common node and one of the transmitter output terminals.

25. The circuit of claim 20 wherein each of the first and second programmable resistance comprises:
first and second resistors connected in series at a common node which is one of the transmitter output terminals;
a first transistor source/drain connected in series with the first resistor, the gate of the first transistor being coupled to receive a signal output from the control circuit;
a second transistor source/drain connected in series with the second resistor, the gate of the second transistor being coupled to receive a signal output from the control circuit.

26. The circuit of claim 20 wherein each of the first and second programmable resistance comprises:
first and second transistors source/drain connected in series at a common node which is one of the transmitter output terminals, the gates of the first and second transistors being coupled to receive signals output from the control circuit.

27. An impedance matching circuit for a transmitter connected to a load at an output terminal, comprising:
a programmable resistance connected between the output terminal and a reference voltage;
a comparator circuit having a first input receiving a fixed reference voltage and a second input receiving a sensed voltage from the output terminal; and
a control circuit responsive to an output of the comparator circuit to adjust the programmable resistance so as to reduce a difference between the fixed reference voltage and sensed voltage as measured by the comparator circuit.

28. The circuit of claim 27 wherein programmable resistance comprises:
first and second transistors source/drain connected in series at a common node, the gates of the first and second transistors being coupled to receive signals output from the control circuit; and
a resistor connected between the common node and the transmitter output terminal.

29. The circuit of claim 27 wherein the programmable resistance comprises:
first and second resistors connected in series at a common node which is the transmitter output terminal;
a first transistor source/drain connected in series with the first resistor, the gate of the first transistor being coupled to receive a signal output from the control circuit;
a second transistor source/drain connected in series with the second resistor, the gate of the second transistor being coupled to receive a signal output from the control circuit.

30. The circuit of claim 27 wherein the programmable resistance comprises:
first and second transistors source/drain connected in series at a common node which is the transmitter output terminal, the gates of the first and second transistors being coupled to receive signals output from the control circuit.
